(19) United States
(12) Patent Application Publication
(10) Pub. No.: US 2010/0307979 A1
(43) Pub. Date: Dec. 9, 2010

(54) CHELATE RESIN

(75) Inventors: Reinhold Klipper, Cologne (DE); Michael Schelhaas, Cologne (DE); Stefan Neumann, Leverkusen (DE); Duilio Rossoni, Langenfeld (DE); Wolfgang Zarges, Cologne (DE)

Correspondence Address: LANXESS CORPORATION, 111 RIDC PARK WEST DRIVE, PITTSBURGH, PA, 15275-1112, US

(73) Assignee: LANXESS DEUTSCHLAND GMBH, Leverkusen (DE)

(21) Appl. No.: 12/669,969

(22) PCT Filed: Jul. 10, 2008
(86) PCT No.: PCT/EP08/59005

§ 371 Date: Aug. 27, 2010

(30) Foreign Application Priority Data
Jul. 23, 2007 (DE) 10 2007 034 731.8

(51) Int. Cl. B01D 15/04; B01J 41/14; B01D 53/02

(52) U.S. Cl. 210/688; 521/32; 95/133

(57) ABSTRACT

The present application relates to novel chelate resins which contain, as a functional group, quaternary nitrogen atoms in structures of the general formula (I)

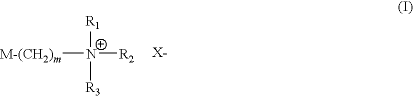

in which at least one of the radicals R₁ to R₃ represents an optionally substituted radical of the series consisting of picolyl, methylquinoline or methylpiperidine, m represents an integer from 1 to 4 and M represents the polymer matrix and X represents a counterion of the series consisting of hydroxide OH⁻, halide, preferably Cl⁻, Br⁻, or sulphate SO₄²⁻, a process for their preparation and the use thereof, in particular the use of the novel chelate resins in hydrometallurgy and electroplating.

The present application relates to novel chelate resins which contain, as a functional group, quaternary nitrogen atoms in structures of the general formula (I)

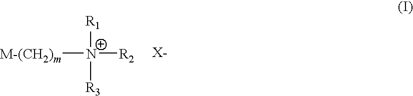

in which at least one of the radicals R₁ to R₃ represents an optionally substituted radical of the series consisting of picolyl, methylquinoline or methylpiperidine, M represents the polymer matrix and m represents an integer from 1 to 4 and X represents a counterion of the series consisting of hydroxide OH⁻, halide, preferably Cl⁻, Br⁻, or sulphate SO₄²⁻, a process for their preparation and the use thereof, in particular the use of the novel chelate resins in hydrometallurgy and electroplating.

For a multiplicity of separation problems in industry, chelate exchangers are already used today. Thus, they are used, inter alia, for removing anions from aqueous or organic solutions, for removing anions from condensates, for removing pigment particles from aqueous or organic solutions or for removing organic components from aqueous solutions, for example for removing humic acids from surface water.

Furthermore, chelate exchangers can be used for the purification and work-up of waters in the chemical industry and electronics industry, in particular for the production of ultrapure water or in combination with gel-like and/or macroporous cation exchangers for the demineralization of aqueous solutions and/or condensates.

Over and above these known applications, it is desired to open up novel fields of use for anion exchangers for which currently known chelate exchangers are not suitable or do not show sufficient absorptivity.

There is therefore a need for novel chelate exchangers based on at least one monovinylaromatic compound or one (meth)acryloyl compound and at least one polyvinylaromatic compound as a crosslinking agent, which show improved exchange kinetics and selectivity for ions to be separated off and show higher mechanical and osmotic stability in column processes than the ion exchangers according to the prior art.

U.S. Pat. No. 4,098,867 and U.S. Pat. No. 4,031,038 describe heterodisperse chelate resins which carry, as a functional group, tertiary nitrogen atoms in structural elements of the formula (II)

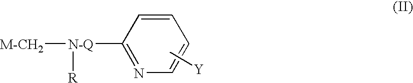

in which
M represents the resin matrix and
Q represents, inter alia, an allylene or —NH radical.

The chelate resins of this prior art are prepared by halomethylation of a bead polymer based on styrene and divinylbenzene, on average 0.1 to 1.0 halomethyl group being introduced per aromatic nucleus as a reactive group for the addition of the aminomethylpyridine chelate functionality.

The halomethylation process described in U.S. Pat. No. 4,098,867 and intended for the introduction of the functional group has disadvantages which lead to a limitation of the degree of functionalization. These disadvantages are described in EP-A 0 481 603. Thus, the halomethylation results in postcrosslinking which leads to a loss of halomethyl groups. Owing to the resultant loss of halomethyl groups which could be reacted with aminomethylpyridines, fewer functional groups are available to the resulting chelate resins for the recovery of valuable metals, which considerably limits the use thereof in metallurgy.

Furthermore, this process is limited from the point of view of variability. The preparation of a multiplicity of chelate resins having quaternary ammonium groups and a high degree of functionalization and high capacity is not possible thereby.

The object of the present invention is to provide chelate exchanger resins having the requirement profile described above for removing substances, preferably polyvalent anions, from liquids, preferably aqueous media or gases, and the preparation of a process for the preparation thereof. Substances in the context of the present invention also include valuable metals.

The solution and hence subject of the present invention are novel monodisperse or heterodisperse, gel-like or macroporous, moderately or strongly basic chelate exchangers based on at least one monovinylaromatic compound and/or (meth)acryloyl compound and at least one polyvinylaromatic compound, which contain, as a functional group, quaternary nitrogen atoms in structures of the general formula (I)

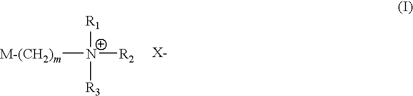

characterized in that at least one of the radicals R₁ to R₃ represents an optionally substituted radical of the series consisting of methylpyridine, methylquinoline or methylpiperidine
and the respective remaining radicals, independently of one another, represent a radical of the series consisting of C₁-C₄-alkyl and hydroxy-C₁-C₄-alkyl, preferably a radical of the series consisting of CH₃, —CH₂OH, —C₂H₄OH, —CH₂CH₂CH₂OH or —CH₂CH₂CH₂CH₂OH, and
m represents an integer 1, 2, 3 or 4,
M represents the polymer matrix and
X represents a counterion of the series consisting of hydroxide OH⁻, halide, preferably Cl⁻, Br⁻, or sulphate SO₄²⁻.

In a preferred embodiment, the chelate exchangers according to the invention may, in addition to the functional group according to the general formula (I), optionally also contain functional groups of the general formula (III)

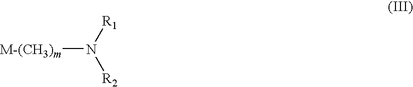

in which
R₁ and R₂, in each case independently of one another, represent a radical of the series consisting of C₁-C₄-alkyl and hydroxy-C₁-C₄-alkyl, preferably a radical of the series consisting of —CH₃, —CH₂OH, —C₂H₄OH, —C₃H₆OH or —C₄H₈OH,
m represents an integer 1, 2, 3 or 4 and

M represents the polymer matrix.

However, the present application also relates to a process for the preparation of these novel monodisperse or heterodisperse, gel-like or macroporous, moderately or strongly basic chelate exchangers which carry, as a functional group, quaternary nitrogen atoms in structures of the general formula (I),

characterized in that
a) monomer droplets comprising a mixture of at least one monovinylaromatic compound and/or a (meth)acryloyl compound, at least one polyvinylaromatic compound, at least one initiator or an initiator combination and optionally a porogen are reacted to give a crosslinked bead polymer,
b) the bead polymer obtained is functionalized with tertiary amino groups and
c) the functionalized bead polymer is reacted with halomethyl-nitrogen heterocycles to give bead polymers having moderately and/or strongly basic anion-exchanging groups which contain methyl-nitrogen heterocycles.

In process step a), at least one monovinylaromatic compound and/or a (meth)acryloyl compound and at least one polyvinylaromatic compound or a polyfunctionally ethylenically unsaturated compound are used. However, it is also possible to use mixtures of two or more monovinylaromatic compounds or mixtures of two or more (meth)acryloyl compounds and mixtures of two or more polyvinylaromatic or one or more polyfunctionally ethylenically unsaturated compound(s).

Monoethylenically unsaturated compounds, particularly preferably styrene, vinyltoluene, ethylstyrene, α-methylstyrene, chlorostyrene, chloromethylstyrene, are preferably used as monovinylaromatic compounds in the context of the present invention in process step a).

Styrene or mixtures of styrene with the abovementioned monomers are particularly preferably used.

Acrylates or methacrylates having branched or straight-chain C₁-C₆-alkyl radicals are preferably used as (meth)acryloyl compounds. Methyl acrylate, acrylonitrile or methacrylonitrile is preferably used.

The preparation of heterodisperse, crosslinked bead polymers and (meth)acryloyl-based ion exchangers obtainable therefrom is described, for example, in U.S. Pat. No. 4,082,564, the content of which with regard to the preparation process of the present description is hereby incorporated in its entirety.

Preferred crosslinking agents in the context of the present invention are, for process step a), polyfunctional ethylenically unsaturated compounds, particularly preferably butadiene, isoprene, divinylbenzene, divinyltoluene, trivinylbenzene, divinylnaphthalene, trivinylnaphthalene, divinylcyclohexane, trivinylcyclohexane, triallylcyanurate, triallylamine, 1,7-octadiene, 1,5-hexadiene, cyclopentadiene, norbornadiene, diethylene glycol divinyl ether, triethylene glycol divinyl ether, tetraethylene glycol divinyl ether, butanediol divinyl ether, ethylene glycol divinyl ether, cyclohexanedimethanol divinyl ether, hexanediol divinyl ether, trimethylolpropane trivinyl ether, ethylene glycol dimethacrylate, trimethylolpropane trimethacrylate or allyl methacrylate. In many cases, divinylbenzene is particularly preferred. For most applications, commercial divinylbenzene grades, which also contain ethylvinylbenzene in addition to the isomers of divinylbenzene, are sufficient.

The polyvinylaromatic compounds are preferably used in amounts of 1-20% by weight, particularly preferably 2-12% by weight, especially preferably 4-10% by weight, based on the monomer or the mixture thereof with further monomers. The type of polyvinylaromatic compounds (crosslinking agents) is chosen with regard to subsequent use of the bead polymer.

The base polymers on which the chelate exchangers according to the invention are based may be present in heterodisperse bead size distribution or monodisperse bead size distribution.

The preparation of the heterodisperse crosslinked base polymers according to process step a) can be effected by known suspension polymerization methods; cf. Ullmann's Encyclopedia of Industrial Chemistry, 5th ed., Vol. A 21, 363-373, VCH Verlagsgesellschaft mbH, Weinheim 1992. The water-insoluble monomer/crosslinking agent mixture is added to an aqueous phase, which preferably contains at least one protective colloid for stabilizing the monomer/crosslinking agent droplets in the disperse phase and the bead polymers forming therefrom.

In a preferred embodiment of the present invention, microencapsulated monomer droplets are used in process step a), the materials known for use as complex coacervates being suitable for the microencapsulation of the monomer droplets, in particular polyesters, natural or synthetic polyamides, polyurethanes, polyureas.

Gelatin is preferably used as the natural polyamide. This is used in particular as a coacervate and complex coacervate. In the context of the present invention, gelatin-containing complex coacervates are understood as meaning especially combinations of gelatin with synthetic polyelectrolytes. Suitable synthetic polyelectrolytes are copolymers having incorporated units, preferably of maleic acid, acrylic acid, methacrylic acid, acrylamide and methacrylamide. Acrylic acid and acrylamide are particularly preferably used. Gelatin-containing capsules can be hardened using customary hardening agents, such as, for example, formaldehyde or glutaraldehyde. The encapsulation of monomer droplets with gelatin, gelatin-containing coacervates or gelatin-containing complex coacervates is described in detail in EP-A 0 046 535. The methods of encapsulation with synthetic polymers are known. For example, phase boundary condensation in which a reactive component dissolved in monomer droplets (for example an isocyanate or an acid chloride) is reacted with a second reactive component dissolved in the aqueous phase (for example an amine) is suitable.

The optionally microencapsulated monomer droplets contain an initiator or mixtures of initiators for initiating the polymerization. Initiators which are preferably suitable for the process according to the invention are peroxy compounds, particularly preferably dibenzoyl peroxide, dilauroyl peroxide, bis(p-chlorobenzoyl)peroxide, dicyclohexyl peroxydicarbonate, tert-butyl peroctanoate, tert-butyl peroxy-2-ethylhexanoate, 2,5-bis(2-ethylhexanoylperoxy)-2,5-dimethylhexane or tert-amylperoxy-2-ethylhexane, and azo compounds, particularly preferably 2,2′-azobis(isobutyronitrile) or 2,2″-azobis(2-methylisobutyronitrile).

The initiator or initiators is or are preferably used in amounts of 0.05 to 2.5% by weight, particularly preferably 0.1 to 1.5% by weight, based on the monomer mixture.

In contrast to the heterodisperse particle size distribution known from the prior art, bead polymers or chelate resins designated as being monodisperse in the present application are those in which at least 90% by volume or by mass of the particles have a diameter which lies in the interval of ±10% of the most frequent diameter about the most frequent diameter.

For example, in the case of a bead polymer having the most frequent diameter of 0.5 mm, at least 90% by volume or by mass are in a size interval between 0.45 mm and 0.55 mm; in the case of a substance having the most frequent diameter of 0.7 mm, at least 90% by volume or by mass are in a size interval between 0.77 mm and 0.63 mm.

A monodisperse, crosslinked, vinylaromatic base polymer according to process step a) can be prepared by the processes known from the literature. For example, such processes are described in U.S. Pat. No. 4,444,961, EP-A 0 046 535, U.S. Pat. No. 4,419,245 or WO 93/12167, the contents of which are incorporated in their entirety in the present application with regard to process step a). According to the invention, monodisperse bead polymers and the monodisperse chelate resins to be prepared therefrom are obtained by jetting or seed/feed processes. According to the invention, the achievement of a monodisperse particle size distribution in process step a) is preferred.

The terms microporous, gel-like and macroporous have already been described in detail in the technical literature. Preferred bead polymers in the context of the present invention, prepared by process step a), have a macroporous structure.

The formation of macroporous bead polymers can be effected, for example, by addition of inert materials (porogens) to the monomer mixture in the polymerization. Organic substances which dissolve in the monomer, but poorly dissolve or swell the polymer (precipitating agent for polymers) are primarily suitable as such, for example aliphatic hydrocarbons (Farbenfabriken Bayer DBP 1045102, 1957; DBP 1113570, 1957).

In U.S. Pat. No. 4,382,124, for example alcohols having 4 to 10 carbon atoms are used as a porogen for the preparation of monodisperse, macroporous bead polymers based on styrene/divinylbenzene. Furthermore, an overview of the preparation methods for macroporous bead polymers is given. Organic solvents which poorly dissolve or swell the polymer formed are preferably suitable as porogens according to the invention. Hexane, octane, isooctane, isododecane, methyl ethyl ketone, butanol or octanol and isomers thereof may be mentioned as being preferred.

The optionally microencapsulated monomer droplets may optionally also contain up to 30% by weight (based on the monomer) of crosslinked or uncrosslinked polymer. Preferred polymers are derived from the abovementioned monomers, particularly preferably from styrene.

The mean particle size of the optionally encapsulated monomer droplets is 10-1000 μm, preferably 100-1000 μm. In the preparation of the monodisperse bead polymers according to process step a), the aqueous phase may optionally contain a dissolved polymerization inhibitor. Suitable as inhibitors in the context of the present invention are both inorganic and organic substances. Examples of inorganic inhibitors are nitrogen compounds, such as hydroxylamine, hydrazine, sodium nitrite or potassium nitrite, salts of phosphorous acid, such as sodium hydrogen phosphate, and sulphur-containing compounds, such as sodium dithionite, sodium thiosulphate, sodium sulphite, sodium bisulphite, sodium thiocyanate or ammonium thiocyanate. Examples of organic inhibitors are phenolic compounds, such as hydroquinone, hydroquinone monomethyl ether, resorcinol, pyrocatechol, tert-butylpyrocatechol, pyrogallol or condensation products of phenols with aldehydes. Further suitable organic inhibitors are nitrogen-containing compounds. These include hydroxylamine derivatives, preferably N,N-diethylhydroxylamine or N-isopropylhydroxylamine, and sulphonated or carboxylated N-alkylhydroxylamine or N,N-dialkylhydroxylamine derivatives, hydrazine derivatives, preferably N,N-hydrazinodiacetic acid, nitroso compounds, preferably N-nitrosophenylhydroxylamine, N-nitrosophenylhydroxylamine ammonium salt or N-nitrosophenylhydroxylamine aluminium salt. The concentration of the inhibitor is 5-1000 ppm (based on the aqueous phase), preferably 10-500 ppm, particularly preferably 10-250 ppm.

The polymerization of the optionally microencapsulated monomer droplets to give the spherical bead polymer is effected, as already mentioned above, optionally in the presence of one or more protective colloids in the aqueous phase. Suitable protective colloids are natural or synthetic water-soluble polymers, such as, for example, gelatin, starch, polyvinyl alcohol, polyvinylpyrrolidone, polyacrylic acid, polymethacrylic acid or copolymers of (meth)acrylic acid and (meth)acrylates. Cellulose derivatives, in particular cellulose esters and cellulose ethers, such as carboxymethylcellulose, methylhydroxyethylcellulose, methylhydroxypropylcellulose and hydroxyethylcellulose, are very suitable. Gelatin is particularly suitable. The amount of protective colloids used is in general 0.05 to 1% by weight, based on the aqueous phase, preferably 0.05 to 0.5% by weight.

The polymerization to give the bead polymer in process step a) can optionally also be carried out in the presence of a buffer system. Buffer systems which adjust the pH of the aqueous phase at the beginning of the polymerization to a value between 14 and 6, preferably between 12 and 8, are preferred. Under these conditions, protective colloids having carboxyl groups are present completely or partly as salts. In this way, the action of the protective colloids is advantageously influenced. Particularly suitable buffer systems contain phosphate or borate salts. The terms phosphate and borate in the context of the invention also comprise the condensates of the ortho-forms of corresponding acids and salts. The concentration of the phosphate or borate in the aqueous phase is 0.5-500 mmol/l, preferably 2.5-100 mmol/1.

The stirring speed during the polymerization is less critical and, in contrast to conventional bead polymerization, has no influence on the particle size. Low stirring speeds which are sufficient for keeping the suspended monomer droplets in suspension and for promoting the removal of the heat of polymerization are used. Various stirrer types can be used for this task. Gate agitators having an axial action are particularly suitable.

The volume ratio of encapsulated monomer droplets to aqueous phase is preferably 1:0.75 to 1:20, particularly preferably 1:1 to 1:6.

The polymerization temperature in process step a) depends on the decomposition temperature of the initiator used. It is in general between 50 and 180° C., preferably between 55 and 130° C. The polymerization takes 0.5 hour to a few hours. It has proved useful to use a temperature programme in which the polymerization is begun at a low temperature, preferably about 60° C., and the reaction temperature is increased with progressing conversion in the polymerization. In this way, for example, the requirement with regard to a safe course of reaction and high conversion of the polymerization can be very readily fulfilled. After the polymerization, the polymer is isolated by customary methods, preferably by filtration or decanting, and is optionally washed.

The crosslinked bead polymer prepared in process step a) and based on monovinylaromatics is functionalized with tertiary amino groups by the phthalimide process. For this purpose, the amidomethylation reagent is firstly prepared in process step b). To this end, preferably phthalimide or a phthalimide derivative is dissolved in a solvent and formalin is added. A bis(phthalimido)ether is then formed therefrom with elimination of water. The bis(phthalimido)ether can optionally be converted into the phthalimido ester. Preferred phthalimide derivatives in the context of the present invention are phthalimide itself or substituted phthalimides, preferably methylphthalimide.

The preparation of a monodisperse bead polymer based on (meth)acryloyl compounds is described in EP-A 1 323 473, the content of which is incorporated in the present invention. The subject of EP-A 1 323 473 is in fact a process for the preparation of monodisperse anion exchangers of the poly(meth)acrylamide type, characterized in that
a) in a first stage, a monomer mixture containing one or more different acryloyl compounds and one or more crosslinking agents or one or more monovinylaromatic compounds and one or more crosslinking agents is jetted or sprayed into a liquid substantially immiscible with the monomer mixture, then encapsulated and polymerized or, after the encapsulation, reacted (fed) with a feed comprising acryloyl compounds and crosslinking agents by a seed/feed process and polymerized, and
b) the product obtained from the first stage is introduced into liquid amines of the diamine type, the suspension is heated to temperatures greater than 100° C. and stirred for several hours, optionally while distilling off resulting components, and the aminated bead polymer is washed amine-free.

A bead polymer to be used according to the invention in stage b) of the process according to the invention and based on (meth)acryloyl compounds is obtained as an intermediate. The term (meth)acryloyl compounds comprises compounds based on acrylic acid or based on methacrylic acid.

Solvents used in process step b) are inert solvents which are suitable for swelling the polymer, preferably chlorinated hydrocarbons, particularly preferably dichloroethane or methylene chloride.

In process step b), the bead polymer is condensed with phthalimide derivatives. Oleum, sulphuric acid or sulphur trioxide is preferably used as a catalyst therein.

The elimination of the phthalic acid radical and hence the liberation of the aminomethyl group are effected in process step c) by treatment of the phthalimidomethylated crosslinked bead polymer with aqueous or alcoholic solutions of an alkali metal hydroxide, preferably sodium hydroxide or potassium hydroxide, at temperatures between 100 and 250° C., preferably 120-190° C. The concentration of the sodium hydroxide solution is preferably in the range of 10 to 50% by weight, particularly preferably in the range from 20 to 40% by weight. This process permits the preparation of crosslinked bead polymers containing aminoalkyl groups and having a substitution of the aromatic nuclei which is greater than 1

The resulting aminomethylated bead polymer is finally washed alkali-free with demineralized water.

The crosslinked bead polymer to be prepared alternatively according to process step a) and based on (meth)acryloyl compounds is functionalized with tertiary amino groups by a procedure in which the bead polymer is reacted either with dimethylaminopropylamine or with other diamines, such as ethylenediamine, diethylenetriamines, triethylenediamines, and then further functionalized to give tertiary amines.

In process step c), the preparation of the ion exchanger according to the invention is effected by reacting the monodisperse or heterodisperse crosslinked, vinylaromatic bead polymers from step b) which contain tertiary amino groups in aqueous suspension with optionally substituted chloromethyl-nitrogen-heterocycles, preferably with chloromethylpyridine or its hydrochloride, 2-chloromethylquinoline or 2-chloromethylpiperidine.

Chloromethylpyridine or its hydrochloride can be used as 2-chloromethylpyridine, 3-chloro-methylpyridine or 4-chloromethylpyridine.

2-Chloromethylpyridine hydrochloride is used as a preferred reagent in process step c), preferably in aqueous solution.

In a preferred embodiment, the reaction in process step c) is carried out with addition of alkali, particularly preferably of potassium hydroxide solution or sodium hydroxide solution, especially preferably of sodium hydroxide solution. By addition of alkali in the reaction of the crosslinked, vinylaromatic base polymer containing aminomethyl groups from process step c) in aqueous suspension with halomethyl-nitrogen-heterocycles, preferably picolyl chloride or its hydrochloride, the pH during the reaction is kept in the range 4-10. Preferably, the pH is kept in the range 6-8.

The ion exchangers prepared according to the invention and having chelating functional groups are suitable for the adsorption of metals, in particular heavy metals and noble metals, and their compounds from aqueous solutions, organic liquids or gases, preferably from acidic, aqueous solutions. The ion exchangers prepared according to the invention and having chelating groups are particularly suitable for removing heavy metals or noble metals from aqueous solutions, in particular from aqueous solutions of alkaline earth metals or alkali metals, from sols of alkali metal chloride electrolysis, from aqueous hydrochloric acids, from wastewaters or flue gas scrubbing, but also from liquid or gaseous hydrocarbons, carboxylic acids, such as adipic acid, glutaric acid or succinic acid, natural gases, natural gas condensates, mineral oils or halohydrocarbons, such as chloro- or fluorohydrocarbons or fluoro/chlorohydrocarbons. In addition, the ion exchangers according to the invention are suitable for removing alkaline earth metals from sols, as are usually used in alkali metal chloride electrolysis. The ion exchangers according to the invention are, however, also suitable for removing heavy metals, in particular iron, chromium, cadmium or lead, from substances which are converted into adiponitrile during an electrolytic treatment, for example a dimerization of acrylonitrile.

The ion exchangers prepared according to the invention are very particularly suitable for removing mercury, iron, chromium, cobalt, nickel, copper, zinc, lead, cadmium, manganese, uranium, vanadium, elements of the platinum group and gold or silver from the abovementioned solutions, liquids or gases.

The ion exchangers according to the invention are particularly suitable for removing rhodium or elements of the platinum group and gold, silver or rhodium or noble metal-containing catalyst residues from organic solutions or solvents.

In addition to the metallurgy for recovering valuable metals, the monodisperse or heterodisperse chelate exchangers according to the invention, having a quaternary nitrogen atom in the functional group of the general formula (I), are outstandingly suitable for a very wide range of applications in the chemical industry, in the electronics industry, in the waste disposal/recycling industry or in electroplating or surface technology.

### Methods of Investigation

### Determination of the Amount of Basic Aminomethyl Groups in the Aminomethylated, Crosslinked Polystyrene Bead Polymer:

100 ml of the aminomethylated bead polymer are vibrated on the tamping voltmeter and then rinsed into a glass column with demineralized water. 1000 ml of 2% strength by weight sodium hydroxide solution are filtered over in 1 hour and 40 minutes. Thereafter, demineralized water is filtered over until 100 ml of eluate, admixed with phenolphthalein, have a consumption of at most 0.05 ml of 0.1 N (0.1 normal) hydrochloric acid.

50 ml of demineralized water and 100 ml of 1 N hydrochloric acid are added to 50 ml of this resin in a beaker. The suspension is stirred for 30 minutes and then introduced into a glass column. The liquid is discharged. A further 100 ml of 1 N hydrochloric acid are filtered over the resin in 20 minutes. 200 ml of methanol are then filtered over. All eluates are collected and combined and are titrated with 1 N sodium hydroxide solution against methyl orange.

The amount of aminomethyl groups in 1 litre of aminomethylated resin is calculated according to the following formula: (200−V)•20=mol of aminomethyl groups per litre of resin.

### Determination of the Amount of Weakly and Strongly Basic Groups in Chelate Exchangers:

100 ml of chelate exchanger are treated with 1000 ml of 2% strength by weight sodium hydroxide solution in a column in 1 hour and 40 minutes. Thereafter, the resin is washed with demineralized water to remove the excess of sodium hydroxide solution.

### Determination of the NaCl Number:

50 ml of the exchanger in free base form and washed neutral are introduced into a column and treated with 950 ml of 2.5% strength by weight sodium chloride solution. The discharge is collected and made up to 1 litre with demineralized water, and 50 ml thereof are washed with 0.1 N hydrochloric acid (=0.1 normal hydrochloric acid).

Consumed ml of 0.1 N hydrochloric acid×4/100=NaCl number in mol/l of resin.

### Determination of the NaNo₃ Number:

950 ml of 2.5% strength by weight sodium nitrate solution are then filtered over. The discharge is made up to 1000 ml with demineralized water. An aliquot part thereof—10ml—is removed and is analysed with respect to its chloride content by titration with mercury nitrate solution.

Consumed ml of Hg(NO₃) solution×factor/17.75=NaNO₃ number in mol/l of resin.

### Determination of the HCl Number:

The resin is washed with demineralized water and rinsed into a beaker. 100 ml of 1 N hydrochloric acid are added and the mixture is left to stand for 30 minutes. The entire suspension is rinsed into a glass column. A further 100 ml of hydrochloric acid are filtered over the resin. The resin is washed with methanol. The discharge is made up to 1000 ml with demineralized water. About 50 ml thereof are titrated with 1 N sodium hydroxide solution.

(20−consumed ml of 1 N sodium hydroxide solution)/5=HCl number in mol/l of resin.

The amount of strongly basic groups is equal to the sum of NaNO₃ number and HCl number.

The amount of weakly basic groups is equal to the HCl number.

Demineralized water in the context of the present invention is characterized in that it has a conductivity of 0.1 to 10 μS, the content of dissolved or undissolved metal ions being not greater than 1 ppm, preferably not greater than 0.5 ppm for Fe, Co, Ni, Mo, Cr, Cu as individual components, and being not greater than 10 ppm, preferably not greater than 1 ppm, for the sum of said metals.

### EXAMPLE 1

### 1a) Preparation of a Monodisperse, Macroporous Bead Polymer Based on Styrene, Divinylbenzene and Ethylstyrene

3000 g of demineralized water were initially introduced into a 10 l glass reactor and a solution of 10 g of gelatin, 16 g of disodium hydrogen phosphate dodecahydrate and 0.73 g of resorcinol in 320 g of demineralized water was added and thorough was effected. The mixture was mixing at 25° C. A mixture of 3200 g of microencapsulated monomer droplets having a narrow particle size distribution and comprising 3.6% by weight of divinylbenzene and 0.9% by weight of ethylstyrene (used as a commercially available isomer mixture of divinylbenzene and ethylstyrene with 80% of divinylbenzene), 0.5% by weight of dibenzoyl peroxide, 56.2% by weight of styrene and 38.8% by weight of isododecane (industrial isomer mixture having a high proportion of pentamethylheptane) was then added with stirring, the microcapsules consisting of a formaldehyde-hardened complex coacervate comprising gelatin and a copolymer of acrylamide and acrylic acid, and 3200 g of aqueous phase having a pH of 12 were added. The mean particle size of the monomer droplets was 460 μm.

The batch was polymerized with stirring by increasing the temperature according to a temperature programme beginning at 25° C. and ending at 95° C. The batch was cooled, washed over a 32 μm sieve and then dried in vacuo at 80° C. 1893 g of a spherical polymer having a mean particle size of 440 μm, a narrow particle size distribution and a smooth surface were obtained.

The bead polymer possessed a chalky white appearance and had a bulk density of about 370 g/1.

### 1b) Preparation of an Amidomethylated Bead Polymer

At room temperature, 1856.3 ml of dichloroethane, 503.5 g of phthalimide and 351 g of 29.9% strength by weight formalin were initially introduced. The pH of the suspension was adjusted to 5.5 to 6 with sodium hydroxide solution. The water was then removed by distillation. 36.9 g of sulphuric acid were then metered in. The resulting water was removed by distillation. The batch was cooled. At 30° C., 134.9 g of 65% strength oleum and then 265.3 g of monodisperse bead polymer, prepared according to process step 1a), were metered in. The suspension was heated to 70° C. and stirred at this temperature for a further 6 hours. The reaction liquor was taken off, demineralized water was metered in and residual amounts of dichloroethane were removed by distillation.

Yield of amidomethylated bead polymer: 1700 ml
Composition according to elemental analysis:
Carbon: 75.1% by weight;
Hydrogen: 4.7% by weight;
Nitrogen: 5.8% by weight;
Remainder: oxygen.

### 1b′) Preparation of an Aminomethylated Bead Polymer

773.3 g of 50% strength by weight sodium hydroxide solution and 1511 ml of demineralized water were metered at room temperature into 1680 ml of amidomethylated bead polymer from 1b). the suspension was heated to 180° C. in 2 hours and stirred at this temperature for 8 hours. The bead polymer obtained was washed with demineralized water.

Yield of aminomethylated bead polymer: 1330 ml
Resulting total yield—projected—1346
Composition according to elemental analysis:
Nitrogen: 11.6% by weight;
Carbon: 78.3% by weight;
Hydrogen: 8.4% by weight.

From the composition of the aminomethylated bead polymer according to elemental analysis, it was possible to calculate that a statistical average per aromatic nucleus—originating from the styrene and divinylbenzene units—of 1.18 hydrogen atoms were substituted by aminomethyl groups.

Determination of the amount of basic groups: 2.17 mol/litre of resin

### 1b″) Preparation of a Bead Polymer Having Tertiary Amino Groups

1875 ml of demineralized water, 1250 ml of aminomethylated bead polymer from 1b′) and 596.8 g of 30.0% strength by weight formalin solution were initially introduced at room temperature into a reactor. The suspension was heated to 40° C. The pH of the suspension was adjusted to pH 3 by metering of 85% strength by weight formic acid. The suspension was heated to reflux temperature (97° C.) within 2 hours. During this time, the pH was kept at 3.0 by metering of formic acid. After reflux temperature had been reached, the pH was adjusted to 2, first by metering of formic acid and then by metering of 50% strength by weight sulphuric acid. Stirring was effected for a further 30 minutes at pH 2.50% strength by weight sulphuric acid was then further metered in and the pH was adjusted to 1. At pH 1 and reflux temperature, stirring was effected for a further 8.5 hours.

The batch was cooled and the resin was filtered off on a sieve and washed with demineralized water.

Volume yield: 2100 ml

In a column, 3000 ml of 4% strength by weight aqueous sodium hydroxide solution was filtered over the resin. Washing with water was then effected.

Volume yield: 1450 ml
Determination of the amount of basic groups: 1.79 mol/litre of resin

### 1c) Reaction of a Bead Polymer Having Tertiary Amino Groups with Picolyl Chloride Hydrochloride to Give a Chelate Resin Having Ammonium Groups Carrying Quaternary Methylpyridine Groups

333 ml of demineralized water were initially introduced into a reactor. 500 ml of anion exchanger from Example 1b″) were metered therein at room temperature. The suspension was heated to 60° C. 183 grams of an 80% strength by weight aqueous solution of picolyl chloride hydrochloride were metered within 4 hours. The pH was kept at pH 7 by metering of 50% strength by weight aqueous sodium hydroxide solution. After the end of metering, stirring was effected for a further 6 hours at pH 7 and 60° C.

The batch was cooled. The bead polymer obtained was filtered off over a sieve and washed with demineralized water.

### Yield: 860 ml

The bead polymer obtained was introduced into a column; 2000 ml of 4% strength by weight aqueous sodium hydroxide solution was filtered over from above. Demineralized water was then filtered over until the pH in the discharge was <9.

Yield of end product: 930 ml

### Composition According to Elemental Analysis

Carbon: 73.6% by weight
Hydrogen: 7.7% by weight
Nitrogen: 9.9% by weight

### Determination of the Amount of Basic Groups—Total Capacity:

NaCl number: 0.24 mol/l
NaNO₃ number: 0.26 mol/l
HCl number: 2.26 mol/l

### Determination of the Amount of Methylpyridine Groups in the Chelate Resin

300 ml of moist anion exchanger from Example 1b″) weighed after drying 144.05 grams.

930 ml of moist end product weighed after drying 238.08 grams.

In the reaction of the starting material to give the end product, there was a weight increase of 238.08−144.05=94.03 grams.

The end product contained 94.03 grams of methylpyridine, corresponding to 1.02 mol of methylpyridine.

Further examples of chelate resins according to the invention, having the structural unit of the formula (I):

(I)

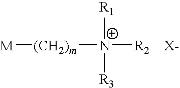

| Ex. | m | R₁ | R₂ | R₃ |
|---|---|---|---|---|
| 2 | 1 | —CH₃ | —CH₃ | 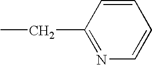 |
| 3 | 2 | —CH₃ | —CH₃ | 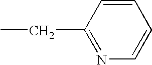 |
| 4 | 3 | —CH₃ | —CH₃ | 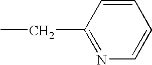 |
| 5 | 4 | —CH₃ | —CH₃ | 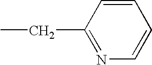 |
| 6 | 1 | —CH₃ | —C₂H₅ | 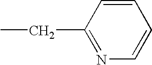 |
| 7 | 1 | —CH₃ | —C₃H₇ | 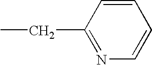 |
| 8 | 1 | —CH₃ | —C₄H₉ | 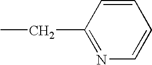 |
| 9 | 1 | —C₂H₅ | —C₂H₅— | 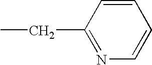 |
| 10 | 1 | —C₃H₇— | —C₃H₇ | 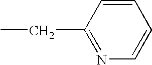 |
| 11 | 2 | —C₂H₅ | —CH₃ | 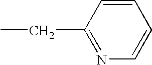 |
| 12 | 2 | —C₃H₇— | —CH₃ | 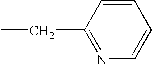 |
| 13 | 2 | —C₄H₉ | —CH₃ | 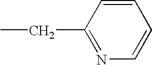 |
| 14 | 1 | —CH₂OH | —CH₃ | 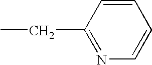 |
| 15 | 1 | —C₂H₄OH | —CH₃ | 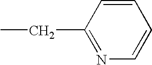 |
| 16 | 1 | —C₃H₆OH | —CH₃ | 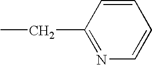 |
| 17 | 1 | —C₄H₈OH | —CH₃ | 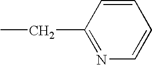 |
| 18 | 1 | —CH₂OH | —CH₂OH | 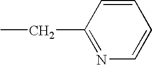 |
| 19 | 1 | —C₂H₄OH | —C₂H₄OH | 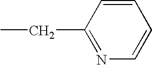 |
| 20 | 1 | —C₃H₆OH | —CH₂OH | 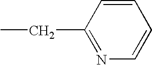 |
| 21 | 1 | —C₄H₈OH | —CH₂OH | 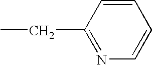 |
| 22 | 2 | —CH₂OH | —CH₃ | 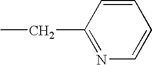 |
| 23 | 2 | —C₂H₄OH | —CH₃ | 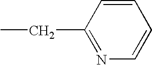 |
| 24 | 2 | —C₃H₆OH | —CH₃ | 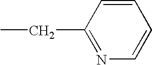 |
| 25 | 2 | —C₄H₈OH | —CH₃ | 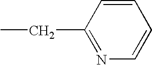 |
| 26 | 1 | —CH₃ | —CH₃ | 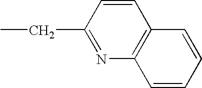 |
| 27 | 2 | —CH₃ | —CH₃ | 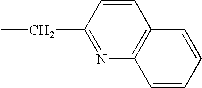 |
| 28 | 3 | —CH₃ | —CH₃ | 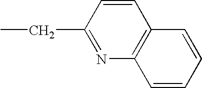 |
| 29 | 4 | —CH₃ | —CH₃ | 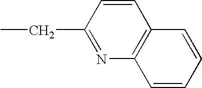 |
| 30 | 1 | —CH₃ | —C₂H₅ | 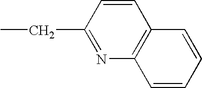 |
| 31 | 1 | —CH₃ | —C₃H₇ | 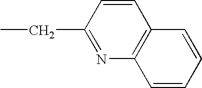 |
| 32 | 1 | —CH₃ | —C₄H₉ | 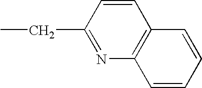 |
| 33 | 1 | —C₂H₅ | —C₂H₅— | 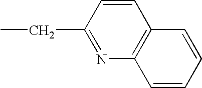 |
| 34 | 1 | —C₃H₇— | —C₃H₇ | 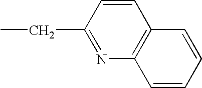 |
| 35 | 2 | —C₂H₅ | —CH₃ | 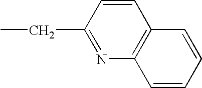 |
| 36 | 2 | —C₃H₇— | —CH₃ | 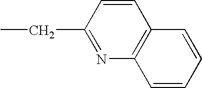 |
| 37 | 2 | —C₄H₉ | —CH₃ | 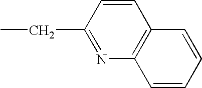 |
| 38 | 1 | —CH₂OH | —CH₃ | 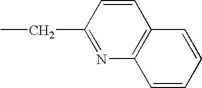 |
| 39 | 1 | —C₂H₄OH | —CH₃ | 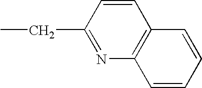 |
| 40 | 1 | —C₃H₆OH | —CH₃ | 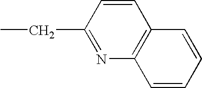 |
| 41 | 1 | —C₄H₈OH | —CH₃ | 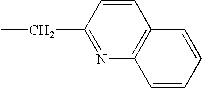 |
| 42 | 1 | —CH₂OH | —CH₂OH | 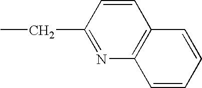 |
| 43 | 1 | —C₂H₄OH | —C₂H₄OH | 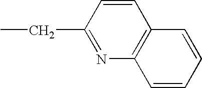 |
| 44 | 1 | —C₃H₆OH | —CH₂OH | 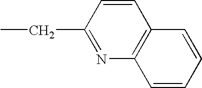 |
| 45 | 1 | —C₄H₈OH | —CH₂OH | 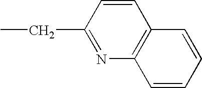 |
| 46 | 2 | —CH₂OH | —CH₃ | 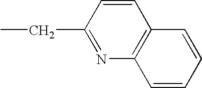 |
| 47 | 2 | —C₂H₄OH | —CH₃ | 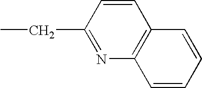 |
| 48 | 2 | —C₃H₆OH | —CH₃ | 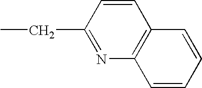 |
| 49 | 2 | —C₄H₈OH | —CH₃ | 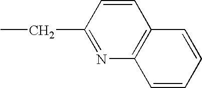 |
| 50 | 3 | —CH₃ | —C₂H₅ | 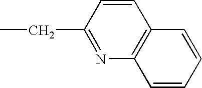 |
| 51 | 1 | —CH₃ | —CH₃ | 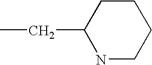 |
| 52 | 2 | —CH₃ | —CH₃ | 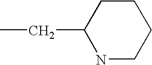 |
| 53 | 3 | —CH₃ | —CH₃ | 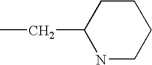 |
| 54 | 4 | —CH₃ | —CH₃ | 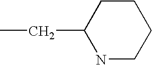 |
| 55 | 1 | —CH₃ | —C₂H₅ | 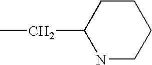 |
| 56 | 1 | —CH₃ | —C₃H₇ | 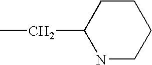 |
| 57 | 1 | —CH₃ | —C₄H₉ | 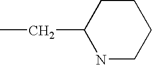 |
| 58 | 1 | —C₂H₅ | —C₂H₅— | 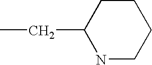 |
| 59 | 1 | —C₃H₇— | —C₃H₇ | 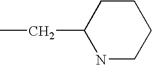 |
| 60 | 2 | —C₂H₅ | —CH₃ | 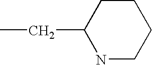 |
| 61 | 2 | —C₃H₇— | —CH₃ | 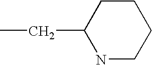 |
| 62 | 2 | —C₄H₉ | —CH₃ | 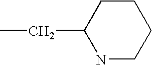 |
| 63 | 1 | —CH₂OH | —CH₃ | 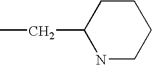 |
| 64 | 1 | —C₂H₄OH | —CH₃ | 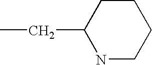 |
| 65 | 1 | —C₃H₆OH | —CH₃ | 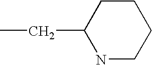 |
| 66 | 1 | —C₄H₈OH | —CH₃ | 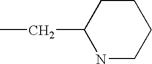 |
| 67 | 1 | —CH₂OH | —CH₂OH | 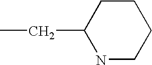 |
| 68 | 1 | —C₂H₄OH | —C₂H₄OH | 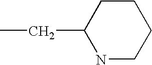 |
| 69 | 1 | —C₃H₆OH | —CH₂OH | 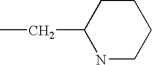 |
| 70 | 1 | —C₄H₈OH | —CH₂OH | 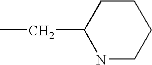 |
| 71 | 2 | —CH₂OH | —CH₃ | 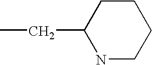 |
| 72 | 2 | —C₄H₈OH | —CH₃ | 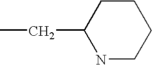 |
| 73 | 2 | —C₃H₆OH | —CH₃ | 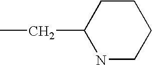 |
| 74 | 2 | —C₄H₈OH | —CH₃ | 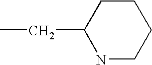 |
| 75 | 3 | —CH₃ | —C₂H₅ | 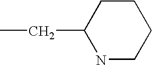 |
| 76 | 1 | —CH₃ | 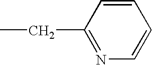 | 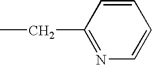 |
| 77 | 2 | —CH₃ | 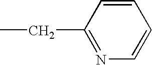 | 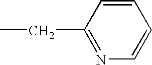 |
| 78 | 3 | —CH₃ | 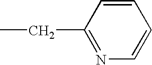 | 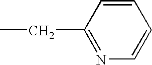 |
| 79 | 4 | —CH₃ | 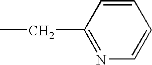 | 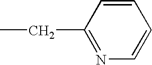 |
| 80 | 1 | —CH₃ | 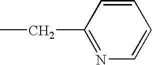 | 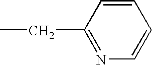 |
| 81 | 1 | —CH₃ | 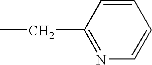 | 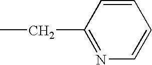 |
| 82 | 1 | —CH₃ | 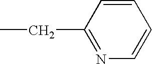 | 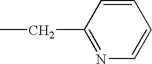 |
| 83 | 1 | —C₂H₅ | 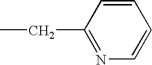 | 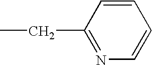 |
| 84 | 1 | —C₃H₇— | 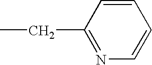 | 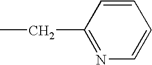 |
| 85 | 2 | —C₂H₅ | 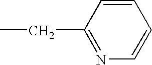 | 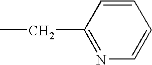 |
| 86 | 2 | —C₃H₇— | 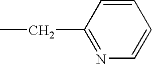 | 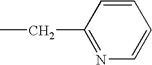 |
| 87 | 2 | —C₄H₉ | 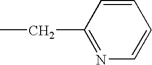 | 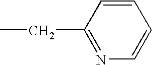 |
| 88 | 1 | —CH₂OH | 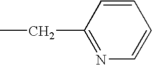 | 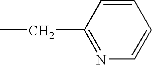 |
| 89 | 1 | —C₂H₄OH | 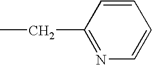 | 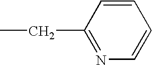 |
| 90 | 1 | —C₃H₆OH | 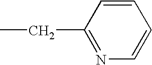 | 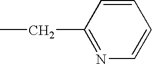 |
| 91 | 1 | —C₄H₈OH | 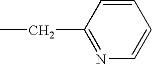 | 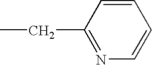 |
| 92 | 1 | —CH₂OH | 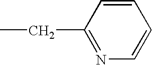 | 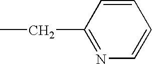 |
| 93 | 1 | —C₂H₄OH | 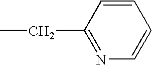 | 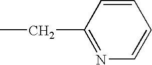 |
| 94 | 1 | —C₃H₆OH | 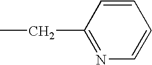 | 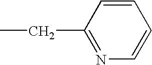 |
| 96 | 1 | —C₄H₈OH | 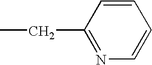 | 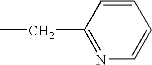 |
| 96 | 2 | —CH₂OH | 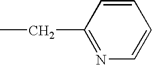 | 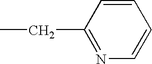 |
| 97 | 2 | —C₂H₄OH | 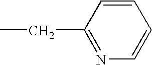 | 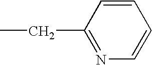 |
| 98 | 2 | —C₃H₆OH | 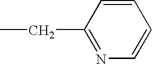 | 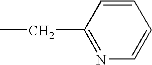 |
| 99 | 2 | —C₄H₈OH | 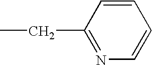 | 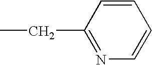 |
| 100 | 3 | —CH₃ | —C₂H₅ | 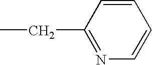 |

1. A chelate exchanger, comprising:
polymerized units of at least one monovinylaromatic compound and/or at least one (meth)acryloyl compound, and
polymerized units of at least one polyvinylaromatic compound,
wherein one or more of said polymerized units of monovinylaromatic compound, (meth)acryloyl compound, and polyvinylaromatic compound contain one or more functional groups, wherein said functional groups conforming structurally to the general formula (I) 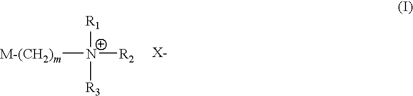
wherein
one of the radicals R₁ to R₃ is an optionally substituted radical of the series consisting of methylpyridine, methylquinoline or methylpiperidine and wherein the respective remaining radicals, independently of one another, represent a radical of the series consisting of C₁-C₄-alkyl and/or hydroxy-C₁-C₄-alkyl, and where
m represents an integer equal to 1, 2, 3 or 4,
M represents a polymer matrix and
X represents a counterion of the series hydroxide OH⁻, halide, Cl⁻, Br⁻, or sulphate SO₄²⁻.

2. The chelate exchanger according to claim 1, wherein said one or more functional groups comprise, in addition to the functional group according to the general formula (I), functional groups of the general formula (III) 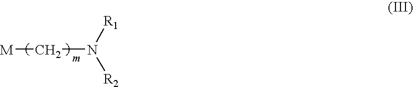
wherein
R₁ and R₂ in each case independently of one another, represent a radical of the series consisting of C₁-C₄-alkyl and/or hydroxy-C₁-C₄-alkyl, and where
m represents an integer equal to 1, 2, 3 or 4 and
M represents the polymer matrix.

3. A process for the preparation of the chelate exchanger according to claim 1, comprising:
a) polymerizing a mixture of monomer droplets of at least one monovinylaromatic compound and/or a (meth)acryloyl compound, at least one polyvinylaromatic compound, at least one initiator or an initiator combination, thereby forming a crosslinked bead polymer,
b) subsequently functionalizing the crosslinked bead polymer with tertiary amino groups thereby forming a functionalized bead polymer, and
c) reacting the functionalized bead polymer with a halomethyl-nitrogen heterocycle.

4. The chelate exchanger according to claim 1, wherein said chelate exchanger has a monodisperse particle size distribution.

5. The chelate exchanger according to claim 1, wherein said chelate exchanger has a macroporous structure.

6. The chelate exchanger according to claim 1, wherein the monovinylaromatic compound is styrene and the polyvinylaromatic compound is divinylbenzene.

7. A process for the adsorption of metals from metal containing aqueous solutions, organic liquids and/or gases, comprising:
contacting said metal containing aqueous solutions, organic liquids and/or gases with the chelate exchanger according to claim 1.

8. The process according to claim 7, wherein said metals are selected from the group consisting of mercury, iron, chromium, cobalt, nickel, copper, zinc, lead, cadmium, manganese, uranium, vanadium, elements of the platinum group, gold, silver, and mixtures thereof.

9. (canceled)

10. The according to claim 1, wherein said radical of the series consisting of C₁-C₄-alkyl and/or hydroxy-C₁-C₄-alkyl is —CH₃, —CH₂OH, —C₂H₄OH, —CH₂CH₂CH₂OH, or —CH₂CH₂CH₂CH₂OH.

11. The according to claim 2, wherein said radical of the series consisting of C₁-C₄-alkyl and/or hydroxy-C₁-C₄-alkyl is —CH₃, —CH₂OH, —C₂H₄OH, —CH₂CH₂CH₂OH, or —CH₂CH₂CH₂CH₂OH
